(19) United States
(12) Patent Application Publication
(10) Pub. No.: US 2026/0125224 A1
(43) Pub. Date: May 7, 2026

(54) CONVEYOR PARCEL ACCUMULATION CHUTE ASSEMBLY

(71) Applicant: FIVES INTRALOGISTICS CORP., Louisville, KY (US)

(72) Inventors: Ray William Cecil, Vine Grove, KY (US); Brandon James Leffler, Fort Worth, TX (US); Steven Russell Asbury, Middleton, OH (US)

(21) Appl. No.: 19/480,812

(22) PCT Filed: Dec. 31, 2024
(86) PCT No.: PCT/US2024/062434

§ 371 Date: Nov. 1, 2025

Related U.S. Application Data
(60) Provisional application No. 63/616,756, filed on Dec. 31, 2023.

(51) Int. Cl. B65G 47/44; B65G 11/08; B65G 43/08

(52) U.S. Cl. CPC B65G 47/44; B65G 11/081; B65G 43/08; B65G 2203/0233; B65G 2203/044

(57) ABSTRACT

A conveyor system has conveyors having conveying surfaces arranged for moving and separating side-by-side packages. Nonconforming parcels are urged off the lateral edge of a selected conveyor onto a downward-sloped chute for removal or recirculation. The parcels often accumulate prior to removal from the chute and cause the conveyor system to halt. To maximize the number of parcels that can accumulate in the chute prior to halting the conveyor system, the geometry of a traditional chute can be modified to direct packages to fill the lower comers of the chute instead of forming a single, narrow stack of packages. The improved chute assembly incorporating anti-towering chute geometry utilizes a floor made from a plurality of surfaces that angled at their common edges to direct packages towards the bottom comers of the chute depending upon the packages'geometry and momentum, thereby preventing the “towering” of packages.

### TECHNICAL FIELD OF THE INVENTION

This invention relates generally to take-off chute configurations for parcel and package conveyors providing cost effective solutions that maximize parcel accumulation onto shoe sorter accumulation chutes.

### BACKGROUND OF THE INVENTION

The present invention relates to material handling and in particular to methods and apparatuses for conveying packages and a mechanism for controlling the location of packages on a take-off conveyor parcel accumulation chute.

Conventional conveyor systems convey large numbers of packages at high speed, especially in the parcel delivery industry wherein the packages are sorted according to desired categories. The efficiency of handling packages can be seriously diminished when a plurality of smaller packages, irregular sized or shaped items, or a mixture of large and small articles pass together on the conveyors as a single unit.

Problems occur with scanning and separating packages and parcels that travel through the conveyor system as an aggregate unit rather than in a single file. Large packages can hide small parcels, and small side-by-side packages can be misidentified and incorrectly sorted when passing simultaneously through a code scanner. Moreover, sorting problems arise when packages do not move in predictable lateral patterns. Such packages may include irregularly shaped packages, such as bags or other flexible containers having unevenly distributed weight; packages with extreme widths or lengths; and packages that are only partially filled, such as a bag of mail.

A singulator is a device used in conveyor systems to organize items into a single-file line. Singulators are often used in logistics, manufacturing, and distribution to ensure that items are properly spaced and aligned for further processing. Singulators help to prevent jams and improve efficiency by separating and aligning items that would otherwise come off the conveyor in bulk. However, rearrangement of clusters of articles into a single-file is difficult to accomplish with packages having one dimension that is significantly greater than its other dimensions, or when the packages have unequal loading, partial filling, or long and slender sides. The singulation is especially difficult over a short distance and residence time, which are desired for efficiency and to conserve floor space. Packages having unequal weight, irregular dimensions, and off-set center of gravity can get repeatably shifted onto the output of the singulation conveyor. Occasionally instead of being positioned in a single file, some of the packages may be conveyed abreast of one another, i.e., in side-by-side relationship traveling two abreast. The combined width of the two packages may present a problem at a downstream location in the conveyor system.

Typical singulator conveyor systems for sorting parcels in typical applications comprise devices that convert a flow of randomly arranged items into single file. The items are conveyed with both forward and lateral forces to align the packages along one side of the conveyor system. Packages that are unable to be sorted and arranged on the primary line are separated by a device that applies lateral forces to the packages, directing the packages to the opposite edge of the conveyor where they fall off the conveyor into a take-off chute. Typical conveyor system configurations recirculate the laterally removed items back upstream to the primary conveyor to provide an additional opportunity to be properly separated and aligned.

Traditional take-off chutes have only a single uniformly sloped flat bottom. Packages having similar momentums exit the conveyor and enter the take-off chute in approximately the same location, thereby causing packages to stack atop one another instead of accumulating across the width of the chute. When a take-off chute becomes filled, a sensor such as a photo eye or limit switch halts the primary conveyor line until more room is made available in the chute. The towering of packages causes the detection sensor to be activated prior to the entire volume of the chute being filled. The halting of the primary conveyor reduces the efficiency of operations. What is needed, therefore, is an economical means to prevent packages from towering in the chute, so that the entire volume of the chute is used effectively.

### SUMMARY OF THE INVENTION

This invention relates generally to take-off chute configurations for parcel and package conveyors providing cost effective solutions that maximize parcel accumulation onto shoe sorter accumulation chutes. A conveyor system has conveyors that convey, align, and organize randomly supplied articles, including side-by-side articles, received from a feed conveyor into a single-file relationship. The articles are conveyed onto a singulator device having separating capabilities which includes a multi-lane conveyor assembly following the feed conveyor. The singulator is arranged in alignment with and downstream of the feed conveyor for receiving articles therefrom. Nonconforming parcels that cannot be aligned appropriately in time are urged off the lateral edge of a selected conveyor onto a downward-sloped chute for removal or recirculation. A detection sensor, or sensors, monitors the top of the chute to ensure that packages are not overflowing from the chute so that packages do not back up on the primary line. If the parcels accumulate in the chute faster than they are removed, the primary line of the conveyor system halts.

To maximize the number of parcels that can accumulate in the chute prior to halting the conveyor system, the geometry of a traditional chute can be improved to direct packages to fill the lower corners of the chute instead of forming a single, narrow stack of packages. The narrow stacking of packages causes the detection sensor to be activated prior to the entire volume of the chute being filled. The improved chute assembly utilizes a floor made from a plurality of surfaces that are angled at their common edges to direct packages towards the bottom corners of the chute, dependent upon the packages' geometry and momentum, thereby preventing the “towering” of packages.

In one preferred embodiment, a first conveying lane has a high-friction surface for conveying articles forward along a vertical side wall. A second conveying lane adjacent thereto has a lower-friction surface including both forward and lateral conveying forces urging parcels forward and away from the first conveyor conveying lane and side wall. Once the package reaches a take-off chute the second conveying lane directs the package laterally until the package's center of gravity extends beyond the outer edge of the second conveying lane, at which time a definite transfer of control will occur as the item drops down into the take-off parcel accumulation chute. The chute then directs the package into a holding area or onto a secondary recirculation conveyor system. The take-off chute comprises a floor composed of multiple angled segments, preferably at least three, to provide efficient parcel distribution and prevent the towering of packages in the chute.

The package diverts from the secondary conveying lane and into the chute at an angle of 20 to 30 degrees. Each package spends a moment on a second surface 2, which is angled downward relative to the lateral direction of motion and upward relative to the forward direction of motion, to slow or stop the forward velocity of the package. Packages that are stopped in the forward direction of motion will then slide laterally down the chute towards a first surface 1 that is angled downward relative to both the original lateral and forward direction of motion of the package. The valley created between the common edge of surface 1 and surface 2 directs packages to the lower left corner of the chute. Packages that maintain some forward momentum after dropping onto surface 2 may continue forward over the top edge of the surface, which forms a peak along the edge shared by surface 2 and third surface 3. Surface 3 is angled downward relative to both the original lateral and forward direction of motion of the package. Packages that overcome the peak are directed towards the bottom right corner of the chute. As packages accumulate in each corner of the chute, the middle fills, and the entirety of the chute it utilized for redirecting and holding packages. Once the chute is filled, packages on surfaces 2 or 3 will block the photo eye or trigger another detection sensor which halts the primary conveying lane.

The method of accumulating parcels in a conveyor shoe sorter accumulator to prevent stacking consists or comprises the steps of incorporating anti-towering chute geometry in a parcel accumulation chute including a first surface, a second surface, and a third surface and selecting an optimal conveyor divert location relative to the parcel accumulation chute geometry to divert the parcels moving forward on the primary conveying lane at an angle of from 20 to 30 degrees onto the parcel accumulation chute. The chute comprises a floor composed of multiple segments seamlessly connected to one another wherein the parcel first enters the parcel accumulation chute on the second surface which is angled downward relative to the lateral direction of motion and upward relative to the forward direction of motion, to slow or stop the forward velocity of the parcel. Any packages stopped in the forward direction of motion will then slide laterally down the chute towards a first surface that is angled downward relative to both the original lateral and forward direction of motion of the parcel and the parcels flow toward a valley created between a common edge of the first surface and the second surface to a lower left corner of the parcel accumulation chute. Packages maintaining forward momentum after dropping onto the second surface continue forward over a top edge of the second surface which forms a peak along an edge shared by the second surface and the third surface whereby the third surface is angled downward relative to both the original lateral and forward direction of motion of the parcel. Parcels overcoming the peak are directed towards a bottom right corner of the parcel accumulation chute. As parcels accumulate in the first lower corner and in the second lower corner a middle section of the package accumulation chute fills utilizing the entirety the package accumulation chute. Upon filling the parcel accumulation chute to a selected level, the packages accumulating on the second surface and/or the third surface block a photo eye or trigger a detection sensor halting the primary conveying lane. A valley between the second surface and the third surface directs parcels to fill the first lower corner. Generally, the first surface is angled from 20 to 22 degrees relative to a floor along an outer side edge and a bottom edge inclines toward the convergence of the first surface, the second surface, and the third surface at a small angle of less than five degrees.

It is an object of the present invention to provide a parcel accumulation chute that mitigates the singular stack-up of packages that prevents the chute from being fully utilized and causes an excessive amount of halting of the primary conveying line.

It is an object of the present invention to provide a parcel accumulation chute having a floor comprising multiple angled surfaces that direct parcels to fill the bottom corners of a holding area, thereby increasing the total useful area of the chute.

It is an object of the present invention to provide a parcel accumulation chute that may be easily segmented to improve its ability to be transported between lines.

It is an object of the present invention to provide a parcel accumulation chute with a floor comprising multiple segments seamlessly connected.

It is an object of the present invention to provide a means to collect and redirect packages traveling abreast of one another so that the packages or articles that are unable to be aligned against a vertical side wall of the conveying lane are carried forward and laterally towards the outer edge, to be deposited in the take-off chute. Once aligned with the entrance of a take-off chute, the packages are moved laterally until the center of gravity of the package is positioned beyond the outer edge of the conveying lane, at which time a definite transfer of control occurs as the item drops into the parcel accumulation chute.

It is an object of the present invention to provide an optimal diversion location for packages relative to the chute geometry.

Other objects, features, and advantages of the invention will become apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 is a perspective view of conventional prior art conveying assembly showing the feed conveyor with a plurality of skewed low friction rollers moving the parcels forward and laterally whereby parcels are transferred across the conveying surface and onto a flat angled parcel accumulation chute;

FIG. 2 is a perspective view of a conveying assembly showing a prior art conventional conveyor having a plurality of skewed rollers conveying parcels off to the side and down a parcel accumulation chute having a single sloped surface whereby a towering problem occurs when parcels stack up onto shoe sorter accumulation chute partially fully the chute;

FIG. 3 shows a flat bottom chute of the prior art with no features to spread the flow of packages and avoid towering, such as the chutes shown in FIGS. 1 and 2;

FIG. 4 is a perspective view of a conveyor with a plurality of skewed low friction rollers moving the parcels forward and laterally whereby parcels are transferred across the conveying surface and onto parcel accumulation chute (“PAC”), assembly with multiple angled surfaces which separates the parcels sliding down the chute to prevent stacking prior to contact with a take-off conveyor;

FIG. 5 is a perspective view of a parcel accumulation chute assembly of FIG. 4 showing the efficient parcel distribution and accumulation of numerous parcels of different sizes and shapes on the angled surfaces due to the anti-towering geometry;

FIG. 6 shows a PAC assembly assembled from multiple segments fastened to a frame with surface geometry to spread the flow of parcels and avoid towering;

FIG. 7 is top view of the PAC illustrating the angle of the first common edge and second common edge relative to the forward and lateral directions of motion;

FIG. 8a illustrates the preferred compound angles for the first angled surface, second angled surface, and third angled surface;

FIG. 8b illustrates the preferred angle of surface 1 relative to surface 2 along segment line x-x;

FIG. 8c illustrates the preferred angle of the first common edge relative to the ground for the segment line y-y;

FIG. 8d illustrates the preferred angle of surface 2 relative to surface 3 along the segment line z-z;

FIG. 8e illustrates the preferred angle of second common edge relative to the ground for the segment line w-w;

FIG. 9 is a front plan view illustrating the angle of the third angle surface with respect to the bottom terminating edges of the first and second angled surfaces;

FIG. 10 is a perspective view of a proposed method of laterally transferring packages from the primary conveyor lane into the PAC, comprising a deflector.

### DETAILED DESCRIPTION OF THE PREFERRED EMBODIMENT

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. As used herein, the term “about” can be reasonably appreciated by a person skilled in the art to denote somewhat above or somewhat below the stated numerical value, to within a range of ±10%.

The method steps, processes, and operations described herein are not to be construed as necessarily requiring their performance in the particular order discussed or illustrated, unless specifically identified as an order of performance. It is also to be understood that additional or alternative steps disclosed herein may be employed in any of the various embodiments discussed herein, regardless of whether such additional or alternative step is expressly disclosed for use in a particular embodiment herein.

The term surface 1 is synonymous with first surface, the term second surface is synonymous with surface 2 and the term third surface is synonymous with surface 3.

The term parcels is synonymous with packages.

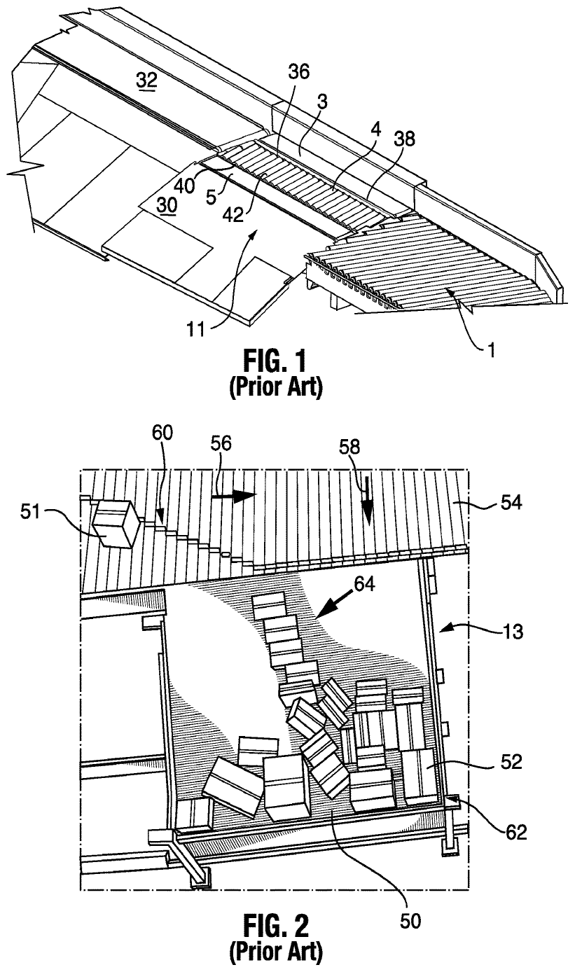

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. FIG. 1 illustrates a conventional prior art conveying assembly showing the feed conveyor 32, first conveying lane having a high-friction belt 3, second conveying lane having low-friction rollers 4, and third conveying lane having a high-friction belt 5, a downstream conveyor 1 and a take-off chute 11 that comprises a declined transverse plane that extends along the lateral edge of the third conveying lane 5.

As shown in FIG. 1, the inner edge 36 of the second conveying lane 4 adjacent the outer edge 38 of the first conveying lane 3 is disposed at a slightly lower elevation along the lateral axis, so that packages resting on both the first conveying lane 3 and the second conveying lane 4 will be held securely and be pulled forward by the first conveying lane 3 having a high-friction surface. The lower-friction conveying surface of the second conveying lane 4 is angled vertically upward at a selected angle of up to 30 degrees from the outer edge 38 of the first conveying lane 3 providing an inclined plane extending upward toward the third conveying lane 5 so that the outer lateral edge 42 of the second conveying lane 4 is equal to or slightly lower than the inner lateral edge 40 of the adjacent third conveying lane 5 whereby articles are removed laterally towards the take-off chute 11 as they move forward progressing on a somewhat inclined plane. The take-off chute 11 comprises a uniformly sloped, declined, transverse plane that directs packages towards a recirculation conveyor or holding area, not shown.

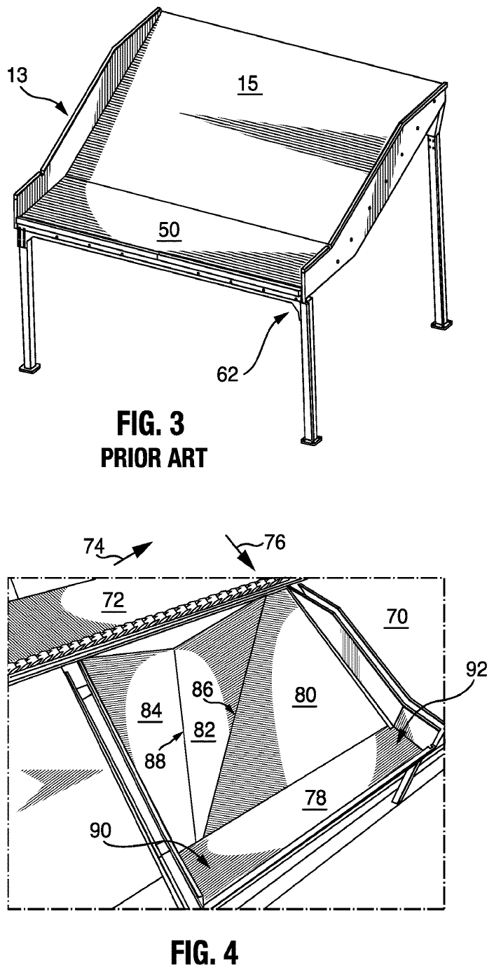

FIG. 2 illustrates a prior art take-off chute 13 having a holding area 50 for the accumulation of non-conforming or misaligned packages 52. An unsorted package 51 moves along the conveyor 54 in a forward direction 56 and lateral direction 58 as indicated by the positional markers 60. The unsorted package 51 is directed off the conveyor 54 at an angle of about 20 to 30 degrees relative to the forward direction of motion 56. Accumulated packages 52 are predisposed towards the bottom right corner 62 of the holding area 50 since the floor 15 of the take-off chute 13 is uniformly sloped, as illustrated in FIG. 3, and therefore has no means by which to change the forward and lateral momentum of entering packages. Due to the proclivity of packages to move towards the bottom right corner of the holding area, eventually the accumulated packages 52 stack, forming a tower 64 which trips a detector, not shown, that causes the conveyor 54 to halt, even though a substantial volume of the take-off chute 13 has not been utilized.

An improved parcel accumulation chute, PAC, 70 is illustrated in FIG. 4. A conveyor 72 with a plurality of skewed low friction rollers moves parcels forward 74 and laterally 76 whereby parcels are transferred across the conveying surface and onto the PAC 70, which, consists, comprises, and comprises essentially of multiple angled surfaces to separate parcels sliding down the chute which prevents stacking. In a preferred embodiment, the improved take-off chute 70 is comprised of at least three angled surfaces which are sloped downward in the lateral direction 76 towards a holding area 78. The first angled surface 80 is angled downward in the forward direction 74, the second angled surface 82 is angled upward in the forward direction, and the third angled surface 84 is angled downward in the forward direction. The surfaces are arranged so that a peak is formed at the first common edge 86 between the first angled surface 80 and the second angled surface 82. A valley is formed at the second common edge 88 between the second angled surface 82 and the third angled surface 84. The valley 88 directs packages towards the bottom left corner 90 of the holding area 78. The first angled surface 80 terminates near the bottom right corner 92 of the holding area 78.

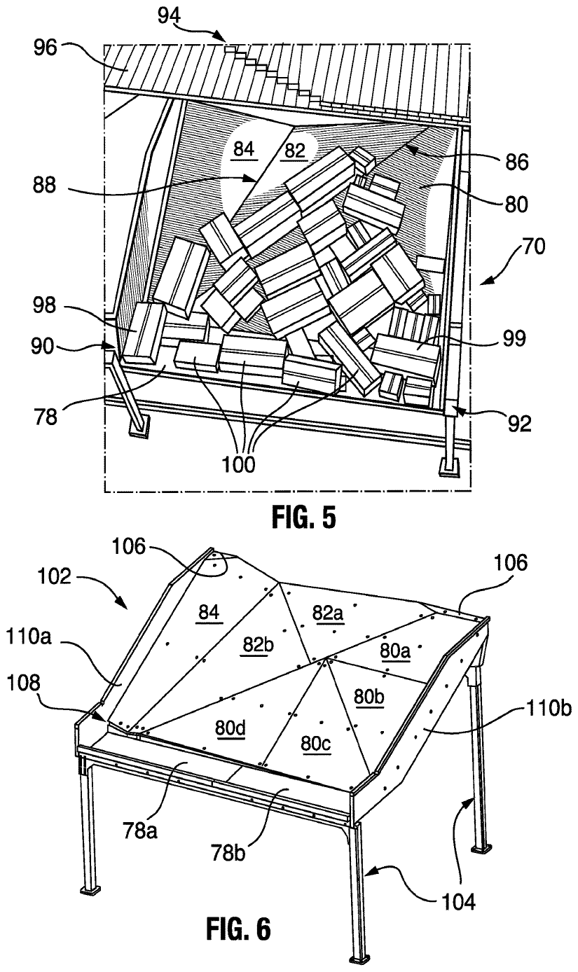

As indicated by the conveyor positional markers 94 in FIG. 5, packages divert from the conveying lane 96 and into the PAC 70 at an angle of preferably 20 to 30 degrees. As packages fall onto the chute, each initially contacts the second angled surface 82. The upward angle of the second angled surface with respect to the forward momentum of the package causes the package to slow or stop in the forward direction 74. Packages that lose all forward momentum will slide laterally down the chute along the valley 88, thereby being directed towards the bottom left corner 90 of the holding area 78, such as a first exemplary package 98. Packages that maintain some forward momentum after contacting the second angled surface 82 may continue forward over the peak 86 between the second angled surface and the third angled surface 84, and thus be directed towards the bottom right corner 92 of the holding area 78, such as a second exemplary package 99. As packages accumulate in the chute 70, the floor's multiple angled surfaces ensure that packages are distributed across the entire width of the chute, and thus the aggregate accumulation of packages 100 does not result in the towering of packages as seen in the prior art.

The floor of the improved PAC 70, comprised of a first angled surface 80, a second angled surface 82, and a third angled surface 84 may be formed as a unitary body through a process such as plastic injection molding, fiber glass lay-up, carbon fiber lay-up, or sheet metal bending. The holding area 78 may additionally be formed as a part of the unitary body or may alternatively be fastened at the bottom of the chute as a separate body. Since the scale of a chute can be increased for large operations, it may alternatively be more practical to install the chute in multiple segments, such as illustrated in FIG. 6, that are then either fastened or welded together.

An exemplary embodiment of a multi-segmented PAC 102 demonstrates how the multiple angled surfaces may be divided and fastened to facilitate easier transportation of the manufactured components. In the exemplary embodiment, the first angled surface 80 is comprised of four coplanar segments 80a-d that are fastened to a frame 104. The second angled surface 82 is comprised of two coplanar segments 82a-b that are fastened to the frame. The third angled surface 84 is comprised of only a single panel that is fastened to the frame. Additional gap filling panels 106 may be installed to ensure a smooth transition between a conveyor and the PAC. The holding area 78 is comprised of two coplanar panels 78a-b that are installed below the terminating edge 108 of the chute 102 to ensure that packages slide completely to the bottom. Further, the PAC 102 comprises side walls 110a and 110b that prevent packages from falling off the sides. The segmentation of the angled surface may readily be modified in shape or size by one who is skilled in the art, and the illustration provided is by no means intended to limit the scope or variation of the segments.

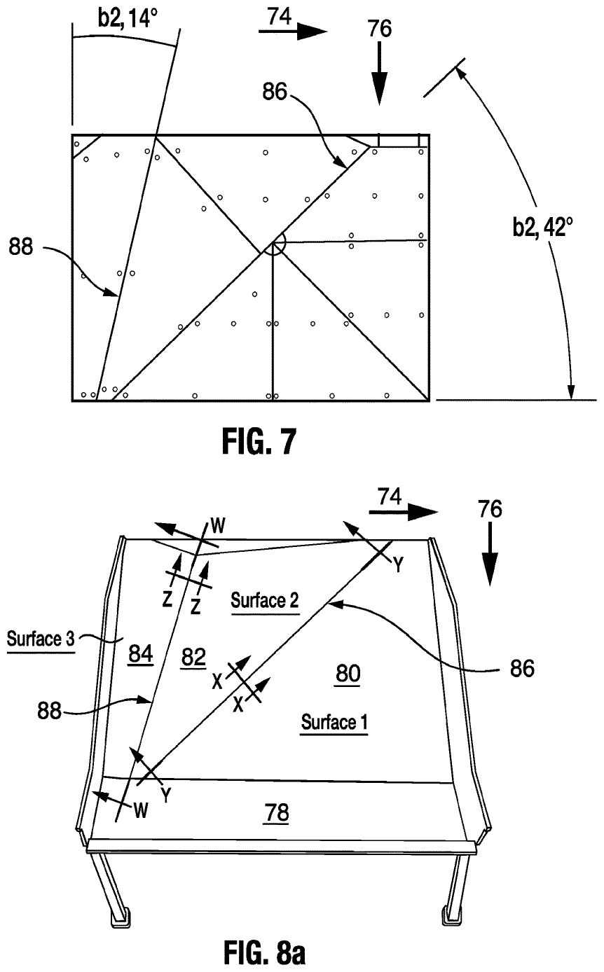

FIG. 7 illustrates a top plan view of the multi-segmented PAC 102. As illustrated, the angle b1 of the first common edge 86 with respect to the forward direction 74 is preferably 30 to 60 degrees, more preferably 40 to 50 degrees, and most preferably 42 degrees. The angle of the second common edge 88 with respect to the lateral direction of the conveyor 76 is preferably 5 to 30 degrees, more preferably 10 to 20 degrees, and most preferably 14 degrees.

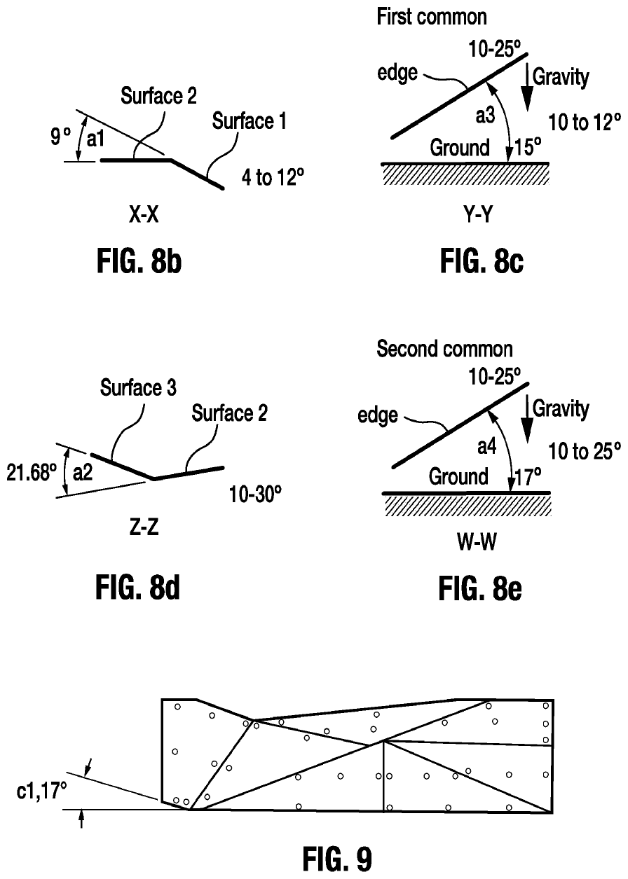

FIG. 8 illustrates the preferred compound angles along and across the first common edge 86 and the second common edge 88 with respect to the angles b1 and b2 provided in FIG. 7, respectively. Regarding the angle of the first common edge 86, the section line X-X is taken orthogonally to the angle b1. The angle al between the first angled surface 80 and the second angled surface 82 along section line X-X is preferably 4 to 12 degrees and most preferably 9 degrees. The angle a3 of the first common edge 86 with respect to the ground is taken along section line Y-Y, with the angle a3 preferably 10 to 25 degrees and most preferably 15 degrees. Regarding the angle of the second common edge 88, the section line Z-Z is taken orthogonally to the angle b2. The angle a2 between the second angled surface 82 and the third angled surface 84 along the section line Z-Z is preferably 10 to 30 degrees and most preferably 22 degrees. The angle of a4 of the second common edge 88 with respect to the ground is taken along section line W-W, with the angle a4 preferably 10 to 25 degrees and most preferably 17 degrees. FIG. 9 illustrates that the angle c1 with respect to the bottom edge 110 of the chute 70, which is parallel to the ground, is preferably 10 to 30 degrees and most preferably 17 degrees.

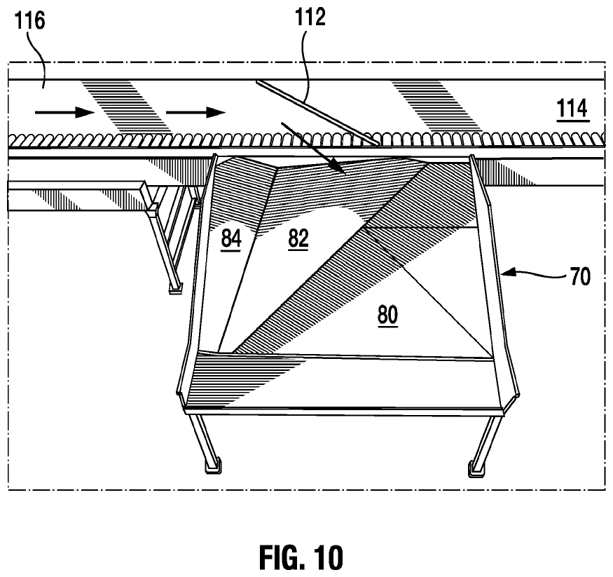

Packages may be directed into the chute by any means that provides forward and lateral movement including skewed low friction roller conveyors which may be combined with high friction conveyor surfaces such as one or more high friction belts to control the flow and direction of parcels. Stationary or powered deflectors, electric and/or air actuators, shoes on slat conveyors, or push type actuators can be utilized to remove or position parcels conveyed on a conveyor at the appropriate time and zone location to optimize the separation efficiency of the parcel accumulation chute. For example, as illustrated in FIG. 10, a deflector 112 may pivot across the width of a conveyor system 114 so to laterally redirect packages from the primary line into the parcel accumulation chute 70 along the path 116.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplifications presented herein above. Rather, what is intended to be covered is within the spirit and scope of the appended claims.

1. A conveyor shoe sorter parcel accumulator chute, comprising:
a floor composed of at least three multiple angled segments incorporating anti-towering chute geometry including a first angled surface, a second angled surface, and a third angled surface sloped downward in a lateral direction toward a holding area;
said first angled surface is angled downward in a forward direction;
said second angled surface is angled in the forward direction;
said third angled surface is angled downward relative to both an original lateral and a forward direction of motion of said parcel;
a peak is formed at a first common edge between said first angled surface and said second angled surface;
a valley is formed at a second common edge between said second angled surface and said third angled surface;
said valley directs packages towards a bottom left first corner of said holding area;
said first angled surface terminates near a bottom right second corner of said holding area; and
a middle holding area is disposed between said left first corner and said right second corner.

2. The conveyor shoe sorter parcel accumulator chute of claim 1, wherein an angle between said first surface and said second surface ranges from 4 to 12 degrees.

3. The conveyor shoe sorter parcel accumulator chute of claim 1, wherein an angle between said first surface and said second surface ranges from 7.5 to 10 degrees.

4. The conveyor shoe sorter parcel accumulator chute of claim 1, wherein an angle between said third surface and said second surface ranges from 10 to 30 degrees.

5. The conveyor shoe sorter parcel accumulator chute of claim 1, wherein an angle between said third surface and said second surface ranges from 15 to 25 degrees.

6. The conveyor shoe sorter parcel accumulator chute of claim 1, wherein said angle between an third surface and said second surface ranges from 18 to 22 degrees.

7. The conveyor shoe sorter parcel accumulator chute of claim 1, wherein an angle of said second surface ranges between 10 to 25 degrees from ground level.

8. The conveyor shoe sorter parcel accumulator chute of claim 1, wherein an angle of said second surface ranges between 12 to 18 degrees from ground level.

9. The conveyor shoe sorter parcel accumulator chute of claim 1, wherein an angle of said first surface ranges between 10 to 25 degrees from ground level.

10. The conveyor shoe sorter parcel accumulator chute of claim 1, wherein an angle of said first surface ranges between 14 to 20 degrees from ground level.

11. The conveyor shoe sorter parcel accumulator chute of claim 1, wherein an angle of said third surface ranges between 14 to 20 degrees from ground level.

12. The conveyor shoe sorter parcel accumulator chute of claim 1, further comprising a deflector in cooperative engagement with said primary conveying lane for diverting said parcels moving forward on a primary conveying lane at an angle of from 20 to 30 degrees onto said parcel accumulation chute.

13. A method of accumulating parcels in a conveyor shoe sorter accumulator to prevent stacking, comprising the steps of:
incorporating anti-towering chute geometry in a parcel accumulation chute including a first surface, a second surface, and a third surface in accordance with claim 1;
selecting an optimal conveyor divert location relative to said parcel accumulation chute geometry;
diverting said parcels moving forward on a primary conveying lane at an angle of from 20 to 30 degrees onto said parcel accumulation chute comprising a floor composed of multiple segments seamlessly connected to one another wherein said parcel first enters said parcel accumulation chute on said second surface which is angled downward relative to the lateral direction of motion and upward relative to the forward direction of motion, to slow or stop a forward velocity of said parcel;
whereby any packages stopped in the forward direction of motion will then slide laterally down the chute towards a first surface that is angled downward relative to both an original lateral and forward direction of motion of the parcel and said parcels flow toward a valley created between a common edge of said first surface and said second surface to a lower left corner of said parcel accumulation chute;
packages maintaining forward momentum after dropping onto said second surface continue forward over a top edge of the said second surface which forms a peak along an edge shared by said second surface and said third surface whereby said third surface is angled downward relative to both the original lateral and forward direction of motion of the parcel;
parcels overcoming said peak are directed towards a bottom right corner of said parcel accumulation chute;
as parcels accumulate in a first lower corner and in a second lower corner a middle section of the package accumulation chute fills utilizing an entirety of said package accumulation chute;
upon filling said parcel accumulation chute to a selected level, said packages accumulating on said second surface and/or said third surface block a photo eye or trigger a detection sensor halting the primary conveying lane.

14. The method of accumulating parcels in the conveyor shoe sorter accumulator of claim 13, wherein a valley between said second surface and said third surface directs parcels to fill said first lower corner.

15. The method of accumulating parcels in the conveyor shoe sorter accumulator of claim 13, wherein said first surface is from 20 to 22 degrees relative to a floor along an outer side edge and a bottom edge inclines toward a convergence of said first surface, said second surface, and said third surface at a small angle of less than five degrees.
